(19) United States
(12) Patent Application Publication
(10) Pub. No.: US 2022/0214885 A1
(43) Pub. Date: Jul. 7, 2022

(54) PARALLEL PROCESSING ARCHITECTURE USING SPECULATIVE ENCODING

(71) Applicant: Ascenium, Inc., Campbell, CA (US)

(72) Inventor: Peter Foley, Los Altos Hills, CA (US)

(73) Assignee: Ascenium, Inc., Campbell, CA (US)

(21) Appl. No.: 17/704,056

(22) Filed: Mar. 25, 2022

Related U.S. Application Data
(63) Continuation-in-part of application No. 17/526,003, filed on Nov. 15, 2021.
Application No. 17/526,003 is a continuation-in-part of application No. 17/465,949, filed on Sep. 3, 2021.
(60) Provisional application No. 63/322,245, filed on Mar. 22, 2022.
(60) Provisional application No. 63/318,413, filed on Mar. 10, 2022.
(60) Provisional application No. 63/295,544, filed on Dec. 31, 2021.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.

(51) Int. Cl. G06F 9/38; G06F 9/30

(52) U.S. Cl. CPC G06F 9/3842; G06F 9/30156

(57) ABSTRACT

Techniques for program execution in a parallel processing architecture using speculative encoding are disclosed. A two-dimensional array of compute elements is accessed, where each compute element within the array of compute elements is known to a compiler and is coupled to its neighboring compute elements within the array of compute elements. Control for the array of compute elements is provided on a cycle-by-cycle basis. The control is enabled by a stream of wide, variable length, control words generated by the compiler. Two or more operations are coalesced into a control word, where the control word includes a branch decision and operations associated with the branch decision. The coalesced control word includes speculatively encoded operations for at least two possible branch paths. The at least two possible branch paths generate independent side effects. Operations associated with the branch decision that are not indicated by the branch decision are suppressed.

### RELATED APPLICATIONS

This application claims the benefit of U.S. provisional patent applications “Parallel Processing Architecture Using Speculative Encoding” Ser. No. 63/166,298, filed Mar. 26, 2021, “Distributed Renaming Within A Statically Scheduled Array ” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, “Load Latency Amelioration Using Bunch Buffers” Ser. No. 63/254,557, filed Oct. 12, 2021, “Compute Element Processing Using Control Word Templates” Ser. No. 63/295,544, filed Dec. 31, 2021, “Highly Parallel Processing Architecture With Out-Of-Order Resolution” Ser. No. 63/318,413, filed Mar. 10, 2022, and “Autonomous Compute Element Operation Using Buffers” Ser. No. 63/322,245, filed Mar. 22, 2022.

This application is also a continuation-in-part of U.S. patent application “Highly Parallel Processing Architecture With Compiler” Ser. No. 17/526,003, filed Nov. 15, 2021, which claims the benefit of U.S. provisional patent applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array ” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

The U.S. patent application “Highly Parallel Processing Architecture With Compiler” Ser. No. 17/526,003, filed Nov. 15, 2021 is also a continuation-in-part of U.S. patent application “Highly Parallel Processing Architecture With Shallow Pipeline” Ser. No. 17/465,949, filed Sep. 3, 2021, which claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array ” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to program execution and more particularly to a parallel processing architecture using speculative encoding.

### BACKGROUND

There has been an explosion in the amount of data that is collected, stored as datasets, analyzed, processed, and used for purposes ranging from surveillance to marketing, among many others. Where data was once stored and accessed as tables in handbooks, pages in laboratory journals, or collections of reports in filing cabinets, the advents of digital data formats and the reduction in costs of digital storage technologies have greatly increased the ease with which the data can be stored and accessed. The data formats permit the storage of a wide variety of kinds of data, such as numbers, sounds, pictures, and movies. The storage technologies allow data to be stored locally, remotely, and securely, and even on small, portable devices. The storage technologies are based on electro-mechanical systems including “hard” disk drives which store the data magnetically on rotating disks. Other storage technologies are based on “solid state” techniques that have no moving parts, where the data is stored using electronic devices such as transistors. Data can also be stored on optical disks and magnetic tapes. The choice of which storage technologies are used is directed based on the amount of data to be stored, the speed with which the data is to be accessed, the frequency with which the data is accessed, and, of course, cost. That is, storage requirements for data that is continuously accessed are more stringent and costly than those requirements for data that is accessed rarely if at all.

The data that is collected is stored as sets of data or datasets, which can be very, very large. The processing of the immense datasets is frequently performed by organizations for commercial, governmental, medical, educational, research, or retail purposes, among many others. These organizations expend vast resources on the data processing because the success or failure of a given organization directly depends on its ability to process the data for the financial and competitive benefit the organization. The organization thrives when the data processing successfully meets the objectives of the organization. Otherwise, if the data processing is unsuccessful, then the organization founders. Many and varied data collection techniques are used to collect the data from a wide and diverse range of individuals. The individuals include customers, citizens, patients, purchasers, students, test subjects, and volunteers. At times the individuals are willing participants, while at other times they are unwitting subjects of data collection. Common data collection techniques include “opt-in” techniques, where an individual signs up, registers, creates an account, or otherwise willingly agrees to participate in the data collection. Other techniques are legislative, such as a government requiring citizens to obtain a registration number and to use that number while interacting with government agencies, law enforcement, emergency services, and others. Additional data collection techniques are more subtle or completely hidden, such as tracking purchase histories, website visits, button clicks, and menu choices. Irrespective of the techniques used for the data collection, the collected data is highly valuable to the organizations. The rapid processing of this data is critical.

### SUMMARY

Organizations perform a large number of mission-critical data processing jobs. The job processing, whether it be for running payroll, analyzing research data, or training a neural network for machine learning, is composed of many complex tasks. The tasks can include loading and storing various datasets, accessing processing components and systems, and so on. The tasks themselves are typically based on subtasks, where the subtasks can be used to handle specific jobs such as loading or reading data from storage, performing computations on the data, storing or writing the data back to storage, handling inter-subtask communication such as data and control, and so on. The datasets that are accessed are often prodigious, and can easily swamp processing architectures that are either ill-suited to the processing tasks or inflexible in their designs. To greatly improve task processing efficiency and throughput, two-dimensional (2D) arrays of elements can be used for the task and subtask processing. The 2D arrays include compute elements, multiplier elements, caches, queues, controllers, decompressors, arithmetic logic units (ALUs), storage elements, and other components, which can communicate among themselves. These arrays of elements are configured and operated by providing control to the array on a cycle-by-cycle basis. The control of the 2D array is accomplished by providing control words generated by a compiler. The control includes a stream of control words, where the control words can include wide, variable length, microcode control words generated by a compiler. The control words are used to configure the array and to control the processing of the tasks and subtasks. Further, the arrays can be configured in a topology which is best suited to the task processing. The topologies into which the arrays can be configured include a systolic, a vector, a cyclic, a spatial, a streaming, or a Very Long Instruction Word (VLIW) topology, among others. The topologies can include a topology that enables machine learning functionality.

Task processing is based on a parallel processing architecture using speculative encoding. A processor-implemented method for task processing is disclosed comprising: accessing a two-dimensional (2D) array of compute elements, wherein each compute element within the array of compute elements is known to a compiler and is coupled to its neighboring compute elements within the array of compute elements; providing control for the array of compute elements on a cycle-by-cycle basis, wherein the control is enabled by a stream of wide, variable length, control words generated by the compiler; and coalescing two or more operations into a control word, wherein the control word includes a branch decision and operations associated with the branch decision. The control word that was coalesced includes speculatively encoded operations for at least two possible branch paths. In embodiments, the branch decision supports subroutine execution. The branch decision can further support a programming loop. The programming loop can include coalescing operations from both the end of the loop and the beginning of the loop.

Embodiments include promoting data for a downstream operation. The downstream operation can include an arithmetic, vector, matrix, or tensor operation; a Boolean operation; and so on. The downstream operation can include an operation within a directed acyclic graph (DAG). The promoting the data produced by the taken branch path can be based on scheduling a commit write, by the compiler, to occur outside a branch indecision window. Further embodiments include suppressing one or more operations associated with the branch decision that are not indicated by the branch decision. The suppressing is accomplished dynamically. The suppressing can include idling compute elements that would have been used to process operations were the operations not suppressed. The suppressing enables power reduction in the 2D array of compute elements. The suppressed operations do not process data, produce data, generate control signals, and so on. In embodiments, the suppressing prevents data from being committed. Further embodiments include removing results from a side of the branch not indicated by the branch decision. The removing the results can be performed to eliminate race conditions, to avoid data ambiguities, etc. The decision to promote taken branch path data is based on the branch decision. Thus, produced data from either branch path cannot be considered valid until the branch decision is performed. In embodiments, operation of the array is halted if a side of the branch not taken attempts to execute a commit write after the branch decision.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a parallel processing architecture using speculative encoding.

FIG. 2 is a flow diagram for operation suppression.

FIG. 3A illustrates a system block diagram for a highly parallel architecture with a shallow pipeline.

FIG. 3B illustrates compute element array detail.

FIG. 4 illustrates branches in code.

FIG. 5A shows code blocks coalesced by a compiler.

FIG. 5B shows a programming loop coalesced by a compiler.

FIG. 6 illustrates a compiler view of a code image.

FIG. 7 shows suppressed operations for an expected branch path.

FIG. 8 illustrates a compressed code word fetch and decompress pipeline.

FIG. 9 shows code word encoding and a naive demand-driven fetch pipeline overlay.

FIG. 10 illustrates a compiler coarse branch prefetch hint.

FIG. 11 shows a system block diagram for compiler interactions.

FIG. 12 is a system diagram for a parallel processing architecture using speculative encoding.

### DETAILED DESCRIPTION

Techniques for program execution based on a parallel processing architecture using speculative encoding are disclosed. The programs that are executed can have a wide range of applications based on data manipulation, such as image or audio processing applications, AI applications, business applications, and so on. The programs can include operations, where the operations can be based on tasks, where the tasks themselves can be based on subtasks. The tasks that are executed can perform a variety of operations including arithmetic operations, shift operations, logical operations including Boolean operations, vector or matrix operations, tensor operations, and the like. The subtasks can be executed based on precedence, priority, coding order, amount of parallelization, data flow, data availability, compute element availability, communication channel availability, and so on. The data manipulations are performed on a two-dimensional (2D) array of compute elements. The compute elements within the 2D array can be implemented with central processing units (CPUs), graphics processing units (GPUs), application specific integrated circuits (ASICs), field programmable gate arrays (FPGAs), processing cores, or other processing components or combinations of processing components. The compute elements can include heterogeneous processors, homogeneous processors, processor cores within an integrated circuit or chip, etc. The compute elements can be coupled to local storage, which can include local memory elements, register files, cache storage, etc. The cache, which can include a hierarchical cache, such as L1, L2, and L3 cache, can be used for storing data such as intermediate results, compressed control words, coalesced control words, decompressed control words, relevant portions of a control word, and the like. The cache can store data produced by a taken branch path, where the taken branch path is determined by a branch decision. The control word is used to control one or more compute elements within the array of compute elements. Both compressed and decompressed control words can be used for controlling the array of elements. Multiple layers of the two-dimensional (2D) array of compute elements can be “stacked” to comprise a three-dimensional array of compute elements.

The tasks, subtasks, etc., that are associated with the operations are generated by a complier. The compiler can include a general-purpose compiler, a hardware description-based compiler, a compiler written or “tuned” for the array of compute elements, a constraint-based compiler, a satisfiability-based compiler (SAT solver), and so on. Control is provided to the hardware in the form of control words, where the control words are provided on a cycle-by-cycle basis. The one or more control words are generated by the compiler. The control words can include wide, variable length, microcode control words. The length of a microcode control word can be adjusted by compressing the control word, by recognizing when a compute element is unneeded by a task so that control bits within the control word are not required for that compute element, etc. The control words can be used to route data, to set up operations to be performed by the compute elements, to idle individual compute elements or rows and/or columns of compute elements, etc. The compiled microcode control words associated with the compute elements are distributed to the compute elements. The compute elements are controlled by a control unit which operates on decompressed control words. The control words enable processing by the compute elements. The task processing is enabled by executing the one or more control words.

In order to accelerate the execution of tasks, to reduce or eliminate stalling for the array of compute elements, and so on, two or more operations can be coalesced into a control word. The compiler can perform the coalescing at compile time, before the control words are loaded into the array of compute elements. The coalesced control word includes a branch decision and operations associated with the branch decision. The coalesced control word can enable partial or complete execution of two or more potential branch decisions or sides. The coalesced control word can enable partial or complete execution a single branch decision that results in two branch paths, or sides. In a usage example, a coalesced control word includes a branch and operations associated with the sides of the branch. Since the outcome of the branch is not likely to be known a priori to execution of the branch, then execution of control words associated with all possible sides of the branch can be started or “pre-executed” using available parallel resources in the array. When the branch decision is made, the operations associated with the indicated side of the branch can proceed. Operations associated with the side of the branch that is not indicated can be suppressed or ignored. Suppressing the operations can include idling compute elements that otherwise would be used to execution the operations associated with the side of the branch not indicated. Suppressing the operations and, by extension, idling compute elements, reduces power consumption within the 2D array. Ignoring the operations increases operational simplicity. Suppressing operations or ignoring operations can be enabled on a compute element basis. A combination of suppressing operations and ignoring operations can be enabled on a compute element basis.

A parallel architecture that uses speculative encoding enables program execution. A two-dimensional (2D) array of compute elements is accessed. The compute elements can include compute elements, processors, or cores within an integrated circuit; processors or cores within an application specific integrated circuit (ASIC); cores programmed within a programmable device such as a field programmable gate array (FPGA), and so on. The compute elements can include homogeneous or heterogeneous processors. Each compute element within the 2D array of compute elements is known to a compiler. The compiler, which can include a general-purpose compiler, a hardware-oriented compiler, or a compiler specific to the compute elements, can compile code for each of the compute elements. Each compute element is coupled to its neighboring compute elements within the array of compute elements. The coupling of the compute elements enables data communication between and among compute elements. Thus the compiler can control data flow between and among the compute elements, as well as controlling data commitment to memory outside of the array. The control is provided to the hardware via one or more control words generated by the compiler. The control can be provided on a cycle-by-cycle basis. The cycle can include a clock cycle, a data cycle, a processing cycle, a physical cycle, an architectural cycle, etc.

The control is enabled by a stream of wide, variable length, control words generated by the compiler. The control words can include microcode control words, an instruction equivalent, a building block for a high-level language, and the like. In embodiments, each operation from the operations represents an instruction equivalent. In embodiments, the instruction equivalent comprises a building block for a high-level language. The control words such as the microcode control word lengths can vary based on the type of control, compression, simplification such as identifying that a compute element is unneeded, etc. The control words, which can include compressed control words, coalesced control words, etc., can be decoded and provided to a control unit which controls the array of compute elements. A coalesced control word can include a branch instruction and one or more operations. The control word can be decompressed to a level of fine control granularity, where each compute element (whether an integer compute element, floating point compute element, address generation compute element, write buffer element, read buffer element, etc.), is individually and uniquely controlled. Each compressed control word is decompressed to allow control on a per element basis. The segment of the control word applied to an individual compute element can be referred to as a bunch. The decoding can be dependent on whether a given compute element is needed for processing a task or subtask; whether the compute element has a specific control word associated with it or the compute element receives a repeated control word (e.g., a control word used for two or more compute elements), and the like. A program is executed on the array of compute elements, based on the set of directions. The execution can be accomplished by executing a plurality of subtasks associated with the compiled task. The executing a plurality of subtasks can comprise executing operations on one or more compute elements within the array of compute elements.

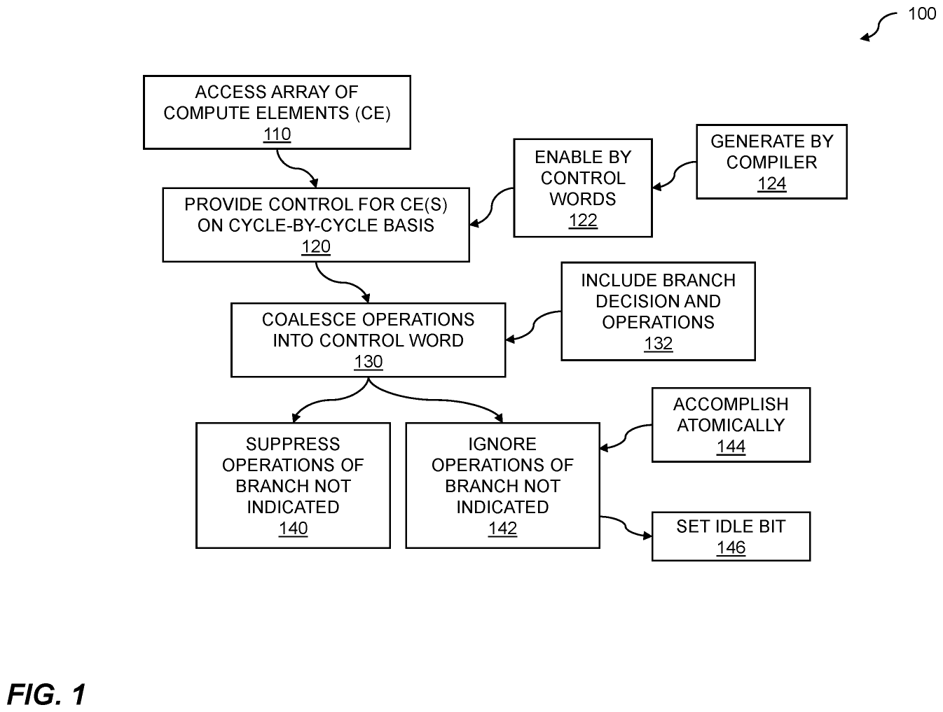

FIG. 1 is a flow diagram for a parallel processing architecture using speculative encoding. Groupings of compute elements (CEs), such as CEs assembled within a 2D array of CEs, can be configured to execute a variety of operations associated with programs. The operations can be based on tasks and subtasks associated with the tasks. The 2D array can further interface with other elements such as controllers, storage elements, ALUs, multiplier elements, and so on. The operations can accomplish a variety of processing objectives such as application processing, data manipulation, and so on. The operations can operate on a variety of data types including integer, real, and character data types; vectors and matrices; tensors; etc. Control is provided to the array of compute elements on a cycle-by-cycle basis, where the control is based on control words generated by a compiler. The control words, which can include microcode control words, enable or idle various compute elements; provide data; route results between or among CEs, caches, and storage; and the like. The control enables compute element operation, memory access precedence, etc. Compute element operation and memory access precedence enable the hardware to properly sequence compute element results. The control enables execution of a compiled program on the array of compute elements. Further, two sides of a branch are speculatively encoded, and coalesced into a control that includes a branch decision and operations associated with the branch decision. When the branch decision is made, the operations associated with the “taken” side of the branch can continue to be executed, can operate on data, etc. The operations associated with the “not taken” side of the branch can be suppressed or ignored. Suppressing the operations for the side of the branch not taken can reduce or prevent execution delay, enable a power reduction, prevent data from being committed, and so on. Ignoring operations can occur when an unwanted data commit is not in process.

The flow 100 includes accessing a two-dimensional (2D) array 110 of compute elements, wherein each compute element within the array of compute elements is known to a compiler and is coupled to its neighboring compute elements within the array of compute elements. The compute elements can be based on a variety of types of processors. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be collocated within a single integrated circuit or chip. The compute elements can be configured in a topology, where the topology can be built into the array, programmed or configured within the array, etc. In embodiments, the array of compute elements is configured by the control word to implement one or more of a systolic, a vector, a cyclic, a spatial, a streaming, or a Very Long Instruction Word (VLIW) topology.

The compute elements can further include a topology suited to machine learning computation. The compute elements can be coupled to other elements within the array of CEs. In embodiments, the coupling of the compute elements can enable one or more topologies. The other elements to which the CEs can be coupled can include storage elements such as one or more levels of cache storage; multiplier units; address generator units for generating load (LD) and store (ST) addresses; queues; and so on. The compiler to which each compute element is known can include a C, C++, or Python compiler. The compiler to which each compute element is known can include a compiler written especially for the array of compute elements. The coupling of each CE to its neighboring CEs enables sharing of elements such as cache elements, multiplier elements, ALU elements, or control elements; communication between or among neighboring CEs; and the like.

The flow 100 includes providing control 120 for the array of compute elements on a cycle-by-cycle basis. The control for the array can include configuration of elements such as compute elements within the array loading and storing data; routing data to, from, and among compute elements; and so on. In the flow 100, the control is enabled 122 by a stream of wide, variable length control words. The control words can configure the compute elements and other elements within the array; enable or disable individual compute elements, rows and/or columns of compute elements; load and store data; route data to, from, and among compute elements; and so on. The one or more control words are generated 124 by the compiler. The compiler which generates the control words can include a general-purpose compiler such as a C, C++, or Python compiler; a hardware description language compiler such as a VHDL or Verilog compiler; a compiler written for the array of compute elements; and the like. The compiler can be used to map functionality to the array of compute elements. In embodiments, the compiler can map machine learning functionality to the array of compute elements. The machine learning can be based on a machine learning (ML) network, a deep learning (DL) network, a support vector machine (SVM), etc. In embodiments, the machine learning functionality can include a neural network (NL) implementation. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data, nor is a control word required by it. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task.

The control words that are generated by the compiler can include a conditionality. In embodiments, the control includes a branch. Code, which can include code associated with an application such as image processing, audio processing, and so on, can include conditions which can cause execution of a sequence of code to transfer to a different sequence of code. The conditionality can be based on evaluating an expression such as a Boolean or arithmetic expression. In embodiments, the conditionality can determine code jumps. The code jumps can include conditional jumps as just described or unconditional jumps such as a jump to a halt, exit, or terminate instruction. The conditionality can be determined within the array of elements. In embodiments, the conditionality can be established by a control unit. In order to establish conditionality by the control unit, the control unit can operate on a control word provided to the control unit. In embodiments, the control unit can operate on decompressed control words. The control words can be a decompressed by a decompressor logic block that decompresses words from a compressed control word cache on their way to the array. In embodiments, the set of directions can include a spatial allocation of subtasks on one or more compute elements within the array of compute elements. In other embodiments, the set of directions can enable multiple programming loop instances circulating within the array of compute elements. The multiple programming loop instances can include multiple instances of the same programming loop, multiple programming loops, etc.

Relevant portions of the control word can be stored within a cache, register file, or other storage associated with the array of compute elements. The control word stored in the decompressed control word (DCW) cache can include a compressed control word, a decompressed control word, and so on. In embodiments, an access queue can be associated with the cache, where the access queues can be used to queue requests to access caches, storage, and so on, for storing data and loading data. The data cache can include a multilevel cache such as a level 1 (L1) cache, a level 2 (L2) cache, and so on. The L1 caches can be used to store blocks of data to be processed. The L1 cache can include a small, fast memory that is quickly accessible by the compute elements and other components. The L2 caches can include larger, slower storage in comparison to the L1 caches. The L2 caches can store “next up” data, results such as intermediate results, and so on. In embodiments, the L1 and L2 caches can further be coupled to level 3 (L3) cache. The L3 caches can be larger than the L2 and L1 caches and can include slower storage. Accessing data from L3 caches is still faster than accessing main storage. In embodiments, the L1, L2, and L3 caches can include 4-way set associative caches. In embodiments, the cache can include a dual read, single write (2R1W) data cache. As the name implies, a 2R1W data cache can support up to two read operations and one write operation simultaneously without causing read/write conflicts, race conditions, data corruption, and the like. In embodiments, the 2R1W data cache can support simultaneous fetch data for potential branch paths for the compiler. Recall that a branch condition can select among two or more branch paths, that is, both the branch path taken and the other branch paths not taken are determined by a branch decision.

The flow 100 includes coalescing two or more operations 130 into a control word. The coalescing can include identifying operations that can be executed independently from one another. Note that a program that can be executed on a 2D array of processors can be represented by a tree, where the branches of the tree can represent sequences of operations or commands to be executed. A decision associated with which branch or branches of the program tree are to be executed can be based on a branch decision. The branch decision can be based on a value such as the value of a variable, a condition, an expression such as a Boolean expression, and so on. In the flow 100, the control word includes a branch decision and operations 132 associated with the branch decision. The operations can be associated with one or more sides of the branch decision. The branch decision can be based on an expected outcome, a predicted outcome, and so on. In embodiments, the control word that was coalesced can include speculatively encoded operations for at least two possible branch paths (or threads). In order for operations to be coalesced, the operations must be independent of one another. The operations may share data such as input data, the tasks performed, or output data generated by an operation associated with one thread. This does not, however, influence the tasks performed or output data generated by an operation associated with another thread. In embodiments, the at least two possible branch paths can generate independent side effects. The independent side effects can include control signals generated, output data to route to another operation, data to be written to storage, and the like. In other embodiments, the at least two possible branch paths can generate compute element actions that must be committed. A compute element action that must be committed can include a write operation to storage external to the 2D array of compute elements. In further embodiments, the at least two possible branch paths can be performed in parallel by the 2D array of compute elements.

The operations that can be coalesced into a control word can configure the compute elements within the 2D array, enable or disable compute elements, and so on. In embodiments, the two or more operations control data flow within the 2D array of compute elements. The data flow can include providing or routing data to a compute element, from a compute element, between or among compute elements, and so on. The data flow can be controlled by one or more bits within a control word. The flow 100 further includes suppressing one or more operations associated with the branch decision that are not indicated 140 by the branch decision. The suppressing can include halting execution of operations associated with the branch decision not indicated, suspending the operations, and so on. In embodiments the suppressing can be accomplished dynamically. In a usage example, the suppressing can occur subsequently to determining a branch decision. Thus, the suppressing can be made “on the fly”, based on the branch decision. The suppressing can accomplish other processing or delay reduction techniques. In embodiments, the suppressing can prevent speculative branch execution delay. In other embodiments, the suppressing can enable power reduction in the 2D array of compute elements. The suppressing of operations can be accomplished by idling compute elements to which the operations now suppressed were assigned. The idling the compute elements reduces an amount of power consumed by the compute elements, and by extension, the amount of power consumed by the 2D array. In further embodiments, the suppressing can prevent data from being committed. Data that is committed can be transferred out of the 2D array of compute elements and stored within storage external to the 2D array. Any data generated by operations that are suppressed can be ignored, thus obviating the need to commit the data.

The flow 100 further includes ignoring one or more operations 142 associated with the branch decision that are not indicated by the branch decision. The ignoring the operations can include ignoring data generated by the operations, such that the control word(s) of the taken branch path makes no use of the results generated by the “speculative” execution of the early part of the path, which turns out not to be taken. In the flow 100, the ignoring is accomplished atomically 144. An atomic operation is an operation that can be isolated from other operations which may be executing parallel to the isolated operation. An atomic operation can be thought to be “indivisible” in that the operation can be executed independently of other operations. In the flow 100, the ignoring is accomplished by setting an idle bit 146 in the control word. The idle bit can be used to enable or idle an individual compute element, to enable or idle rows or columns of compute elements, to transmit control words to individual compute elements, etc. The ignoring can include having the control word(s) of the taken branch path not make further use of a particular control element, and thus set its idle bit.

In some embodiments, certain operations are performed in the array for two or more sides of a branch instruction. The results of the branch path or paths that are not taken can be ignored, and any side effects of the branch path or paths not taken can be cleared or ignored. However, minimizing the number of speculatively performed operations can both minimize the side effects to be cleared or ignored and reduce power consumption in the array. To achieve this, the compiler can implement speculative encoding, where a control word can be speculatively encoded such that the encoding can include operations before a branch, the branch decision operation itself, and operations after the branch on multiple sides of the branch, for both the taken and the non-taken branch paths. Because the array of compute elements can provide a large resource facility, a compressed control word (CCW) can speculatively encode a large number of parallel operations, which can encompass multiple branch paths.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

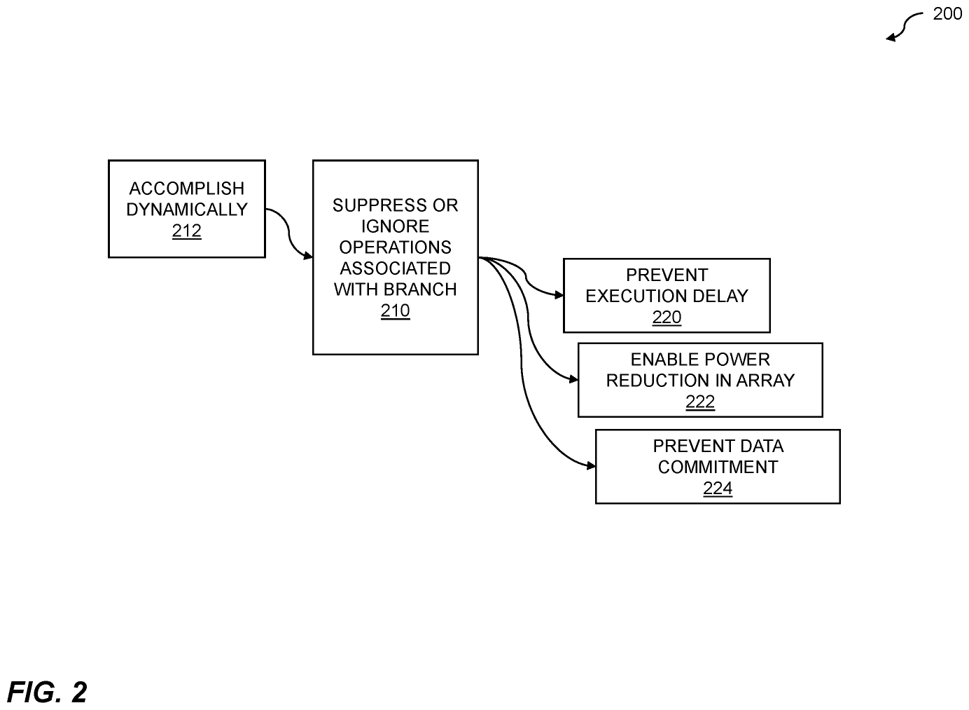

FIG. 2 is a flow diagram for operation suppression. Discussed throughout, programs of various types can be executed on an array of compute elements. The programs include tasks, subtasks, and the like, that can be processed on the compute elements. A task can include general operations such as arithmetic, vector, array, or matrix operations; Boolean operations such as NAND, NOR, XOR, or NOT operations; operations based on applications such as neural network or deep learning operations; and so on. In order for the tasks to be processed correctly, control words are provided on a cycle-by-cycle basis to the array of compute elements. The control words configure the array to execute tasks. The control words can be provided to the array of compute elements by a compiler. The control words can include coalesced control words, where the coalesced control words include a branch decision and operations associated with the branch decision. The providing control words that control placement, scheduling, data transfers, and so on, within the array, can maximize task processing throughput. This maximization ensures that a task that generates data required by a second task is processed prior to the processing of the second task, and so on. A branch decision is based on a task that includes a branch operation. A branch operation can be based on a conditionality, where a conditionality can be established by the program, which controls the operation of the control unit. A branch can include a plurality of “ways”, “paths”, or “sides” that can be taken based on the conditionality. The conditionality can include evaluating an expression such as an arithmetic or Boolean expression, transferring from a sequence of instructions to a second sequence of instructions, and so on. In embodiments, the conditionality can determine code jumps. Since the branch path that will be taken is not known a priori to evaluating the conditionality, operations associated with sides of the branch can be executed on a speculative basis. When the conditionality is determined and a branch decision is made, then operations associated with the taken side can proceed, while operations associated with the not indicated side can be ignored. Further, the operations associated with the not taken side of the branch can be suppressed. Suppression of the operations can be accomplished by idling compute elements that had been configured for the operations associated with the not taken side of the branch. Note this is not done “dynamically” by the control unit—other than directing a control word fetch down the taken path, but rather the control words on the taken side of the branch will idle the speculatively encoded operations for the other side of the branch. This is encoded into the control words at compile time.

The coalesced control word can be determined by speculative encoding. Coalescing control words enables a parallel processing architecture using speculative encoding. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide, variable length, control words generated by the compiler. Two or more operations are coalesced into a control word, wherein the control word includes a branch decision and operations associated with the branch decision.

The flow 200 includes suppressing or ignoring one or more operations 210 associated with the branch decision that are not indicated by the branch decision. The suppressing can include terminating execution of the operations, overwriting or deleting the operations, and so on. The ignoring can include letting an operation in a compute element complete, as long as the state of the system, as known by the compiler, is not corrupted. In the flow 200, the suppressing is accomplished dynamically 212, in the sense that the branch decision is dynamic; the “suppression” is already encoded in the control word(s) of the taken branch path. The suppressing can be based on a branch decision where the branch decision can include a not indicated side of the branch, a not taken side of the branch, and the like. Any results, such as data generated by operations associated with the side of the branch not indicated, are unneeded for further execution of a program, processing of a task, subtask, and so on. Rather than having to expend clock cycles, architectural cycles, etc. associated with the array of compute elements to flush, overwrite, delete, etc., the unneeded data, no cycles are expended in ignoring the data. The subsequent control words “actively” ignore the results that are still in the array, generated by the first few control word(s) of the path not taken both for the control word containing the decision, as well as, in general, a few following control words. In other words, the unwanted results are generated during the brief “branch shadow” following the decision in the array. This is the few cycles following the decision inside the array that it takes to drive the decision out of the array to the control unit, and for the control unit to act on that decision and potentially change the path of the control word(s) fetched. The registers, cache, or other storage associated with the unneeded data can be made available for further processing. Further embodiments can include removing results from a side of the branch not indicated by the branch decision. In the event that leaving data associated with the side of the branch indicated might cause a race condition, data ambiguity, or some other possible processing conflict, the unneeded data can be removed from storage, registers, a cache, etc.

In the flow 200, the suppressing prevents speculative branch execution delay 220, because it allows speculative execution of the path that will not be taken. Discussed throughout, speculative branch execution can be based on executing a control word such as a coalesced control word that was speculatively encoded. A speculatively encoded control word can be based on coalescing a branch instruction and operations associated with the two or more sides of the branch instruction. One of the sides can be taken more often during program execution, can be more likely to be taken, or can otherwise be predicted to be the side of the branch that will be taken. The speculative encoding can include one or more operations from the sides of the branch less likely to be taken. If the branch decision indicates one of the sides of the branch that is less likely to be taken, some of the operations associated with control words for the decided branch side are either available for execution or have already been executed in parallel with operations associated with the other branches. Further control words can be fetched, decoded, and provided to the 2D array of compute elements. Thus, execution delay can be prevented. In the flow 200, the suppressing enables power reduction 222 in the 2D array of compute elements. The power reduction can be accomplished by idling compute elements that can been allocated to operations that are suppressed once the branch decision is made. The idling of compute elements enables the power reduction within the 2D array. In the flow 200, the suppressing prevents data from being committed 224. An operation can access data for processing and can generate output data. The output data from a processed operation is typically stored within storage associated with the 2D array such as a cache, register file, memory, and so on; or stored in storage beyond or external to the 2D array. By suppressing the operations of the side of the branch not indicated, any data resulting from executing the now suppressed operations can be ignored, deleted, overwritten, flushed, and so on. Thus data is not committed by a suppressed operation.

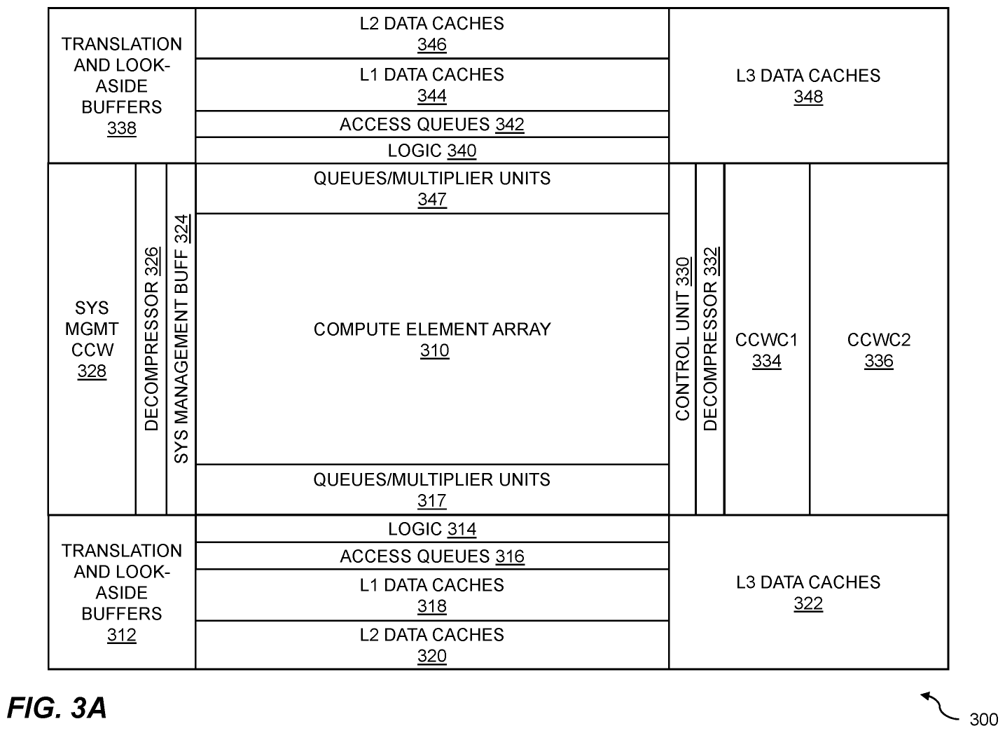

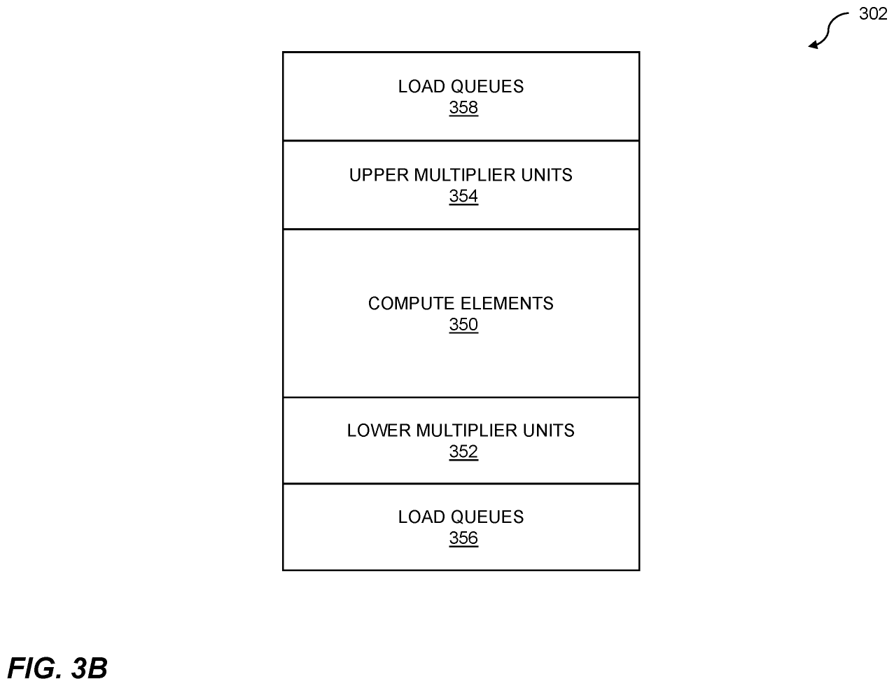

FIG. 3A illustrates a system block diagram for a highly parallel architecture with a shallow pipeline. The highly parallel architecture can comprise components including compute elements, processing elements, buffers, one or more levels of cache storage, system management, arithmetic logic units, and so on. The various components can be used to accomplish task processing, where the task processing is associated with program execution. The task processing is enabled using speculative encoding on the highly parallel processing architecture. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide, variable length, control words generated by the compiler. Two or more operations are coalesced into a control word, wherein the control word includes a branch decision and operations associated with the branch decision.

A system block diagram 300 for a highly parallel architecture with a shallow pipeline is shown. The system block diagram can include a compute element array 310. The compute element array 310 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 300 can include translation and look-aside buffers such as translation and look-aside buffers 312 and 338. The translation and look-aside buffers can complement memory caches, where the memory caches can be used to reduce storage access times. The system block diagram can include logic for load and access order and selection. The logic for load and access order and selection can include logic 314 and logic 340. Logic 314 and 340 can accomplish load and access order and selection for the lower data block (316, 318, and 320) and the upper data block (342, 344, and 346), respectively. This layout technique can double access bandwidth, reduce interconnect complexity, and so on. Logic 340 can be coupled to compute element array 310 through the queues, address generators, and multiplier units 347 component. In the same way, logic 314 can be coupled to compute element array 310 through the queues, address generators, and multiplier units 317 component.

The system block diagram can include access queues. The access queues can include access queues 316 and 342. The access queues can be used to queue requests to access caches, storage, and so on, for storing data and loading data. The system block diagram can include level 1 (L1) data caches such as L1 caches 318 and 344. The L1 caches can be used to store blocks of data such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 320 and 346. The L2 caches can include larger, slower storage in comparison to the L1 caches. The L2 caches can store “next up” data, results such as intermediate results, and so on. The L1 and L2 caches can further be coupled to level 4 (L3) caches. The L3 caches can include L3 caches 322 and 348. The L3 caches can be larger than the L2 and L1 caches and can include slower storage. Accessing data from L3 caches is still faster than accessing main storage. In embodiments, the L1, L2, and L3 caches can include 4-way set associative caches.

The block diagram 300 can include a system management buffer 324. The system management buffer can be used to store system management codes or control words that can be used to control the array 310 of compute elements. The system management buffer can be employed for holding opcodes, codes, routines, functions, etc. which can be used for exception or error handling, management of the parallel architecture for processing tasks, and so on. The system management buffer can be coupled to a decompressor 326. The decompressor can be used to decompress system management compressed control words (CCWs) from system management compressed control word buffer 328 and can store the decompressed system management control words in the system management buffer 324. The compressed system management control words can require less storage than the uncompressed control words. The system management CCW component 328 can also include a spill buffer. The spill buffer can comprise a large static random-access memory (SRAM) which can be used to support multiple nested levels of exceptions.

The compute elements within the array of compute elements can be controlled by a control unit such as control unit 330. While the compiler, through the control word, controls the individual elements, the control unit can pause the array to ensure that new control words are not driven into the array. The control unit can receive a decompressed control word from a decompressor 332. The decompressor can decompress a control word (discussed below) to enable or idle rows or columns of compute elements; to enable or idle individual compute elements; to transmit control words to individual compute elements; etc. The decompressor can be coupled to a compressed control word store such as compressed control word cache 1 (CCWC1) 334. CCWC1 can include a cache such as an L1 cache that includes one or more compressed control words. CCWC1 can be coupled to a further compressed control word store such as compressed control word cache 2 (CCWC2) 336. CCWC2 can be used as an L2 cache for compressed control words. CCWC2 can be larger and slower than CCWC1. In embodiments, CCWC1 and CCWC2 can include 4-way set associativity. In embodiments, CCWC1 cache can contain decompressed control words, in which case it could be designated as DCWC1. In that case, decompressor 332 can be coupled between CCWC1 334 (now DCWC1) and CCWC2 336.

FIG. 3B shows compute element array detail 302. A compute element array can be coupled to components which enable the compute elements to process one or more tasks. The components can access and provide data, perform specific high-speed operations, and so on. The compute element array and its associated components enable a parallel processing architecture using speculative encoding. The compute element array 350 can perform a variety of processing tasks, where the processing tasks can include operations such as arithmetic, vector, or matrix operations, etc. The compute elements can be coupled to multiplier units such as lower multiplier units 352 and upper multiplier units 354. The multiplier units can be used to perform high-speed multiplications associated with general processing tasks, multiplications associated with neural networks such as deep learning networks, multiplications associated with vector operations, and the like. The compute elements can be coupled to load queues such as load queues 356 and load queues 358. The load queues can be coupled to the L1 data caches as discussed previously. The load queues can be used to load storage access requests from the compute elements. The load queues can track expected load latencies and can notify a control unit if a load latency exceeds a threshold. Notification of the control unit can be used to signal that a load may not arrive within an expected timeframe. The load queues can further be used to pause the array of compute elements. The load queues can send a pause request to the control unit that will pause the entire array, while individual elements can be idled under control of the control word. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, that is, it acts as a routing element, it is still considered active.

While the array is paused, background loading of the array from the memories (data and control word) can be performed. The memory systems can be free running and can continue to operate while the array is paused. Because there can be multi-cycle latency due to control signal transport, which results in additional dead time, it can be beneficial to allow the memory system to “reach into” the array and deliver load data to appropriate scratchpad memories while the array is paused. This mechanism can operate such that the array state is known, as far as the compiler is concerned. When array operation resumes after a pause, new load data will have arrived at a scratchpad, as required for compiler to maintain the statically scheduled model.

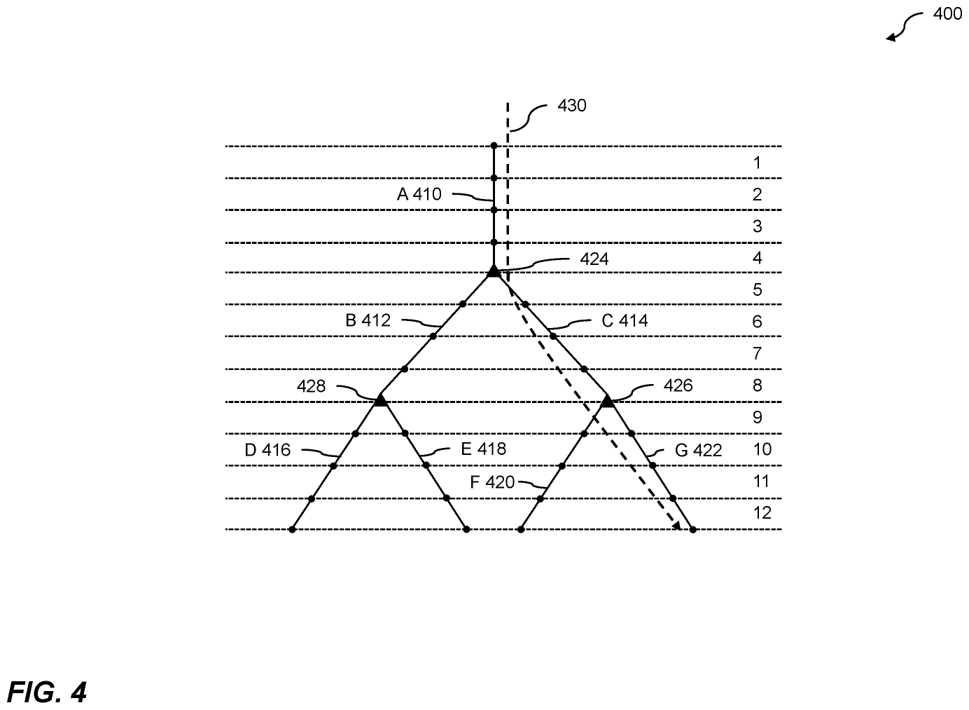

FIG. 4 illustrates branches in code. Codes, programs, applications, apps, and so on can include one or more branches. The branches can include conditional branches, which can be based on a value of a variable, a flag, a signal, etc.; and unconditional branches, which can transfer control, perform a specific number of operations, and the like. One or more operations can be associated with each branch. In embodiments, two or more operations can be coalesced into a control word, where the control word can include a branch decision and operations associated with the branch decision. The coalesced control word can control a parallel processing architecture using speculative encoding. The FIG. 400 illustrates seven segments within an execution tree. The seven segments include segment A 410, segment B 412, segment C 414, segment D 416, segment E 418, segment F 420, and segment G 422. The seven segments can each include operations such as the four operations shown for each segment. Determination of which of the seven segments will be executed can be based on branch points, such as the three branch points shown, branch point 424, branch point 426, and branch point 428. Based on a branch decision made at a branch point, there are four potential paths that can be taken along the seven branches of the tree. The paths can include ABD, ABE, ACF, and ACG. In the figure, the path taken along the branches of the tree, ACG, is denoted by path 430. The execution of the operations associated with the segments of the tree 400 can be based on processing cycles. In the example 400, the operations shown can be executed in thirteen cycles.

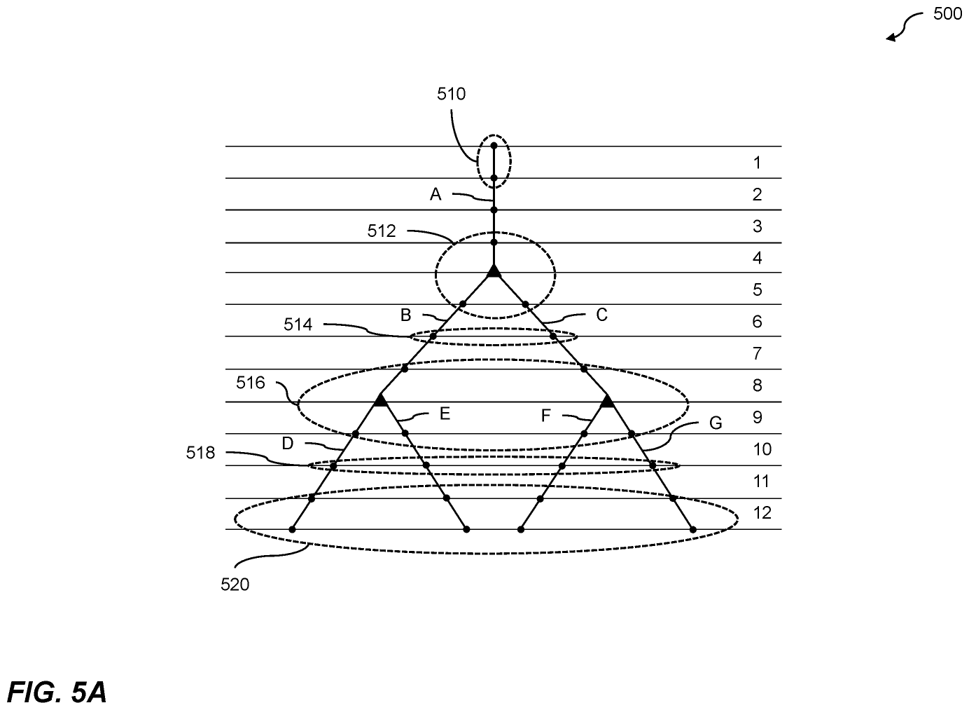

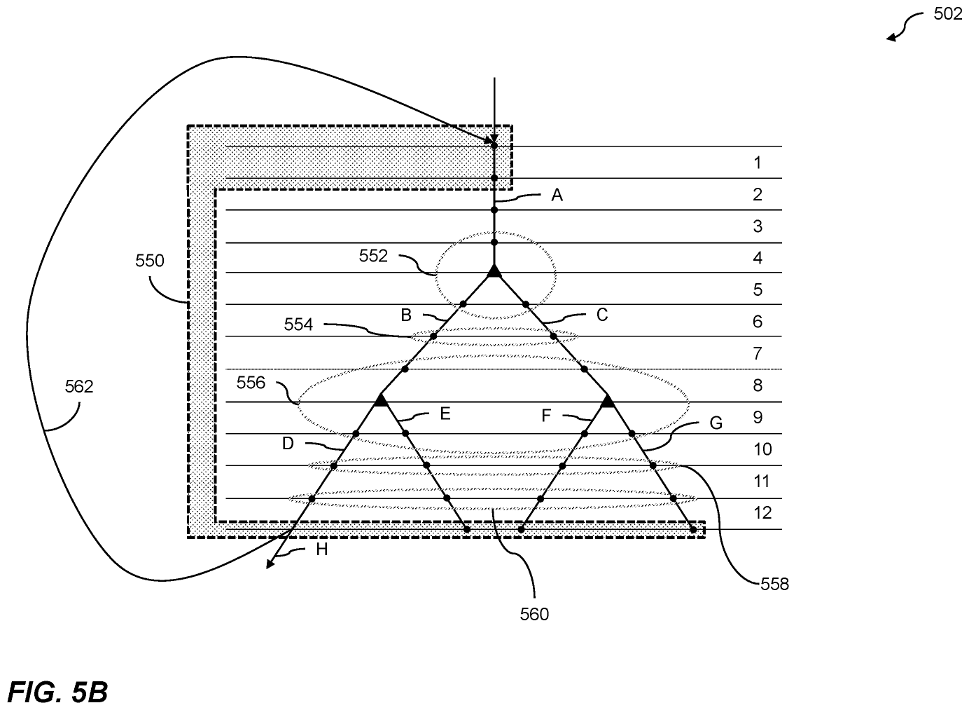

FIG. 5A shows code blocks coalesced by a compiler 500. Discussed throughout, program execution can be based on branching operations, where the branching operations can include conditional branches or unconditional branches. A conditional branch can be based on a value, flag, signal, etc., and can be described using a variety of techniques such as if-then-else techniques, case or switch techniques, etc. An unconditional branch can include an “always taken” branch, which can transfer control, order of operations, and the like. The coalescing can be based on speculative encoding, where the coalesced operations can be executed on a parallel processing architecture. In embodiments, the control word that was coalesced can include speculatively encoded operations for at least two possible branch paths. The coalesced control word can include two or more operations. The coalesced control word can further include speculatively encoded operations for at least two possible branch paths. In order for two or more operations associated with the branch paths to be coalesced into a control word, various conditions can apply. In embodiments, the at least two possible branch paths can generate independent side effects. Side effects can include program execution stalls, increases in functional density of compressed control words, and so on. Program execution stalls can occur while waiting for needed data, for compressed control words to be fetched and decompressed, and so on.

In other embodiments, the at least two possible branch paths can generate compute element actions that must be committed. Compute element actions that must be committed can include writing to storage, where the storage can be external to the array of compute elements. For the purposes of this example, a commit write can include writing data that can be provided to other compute elements within the array of compute elements, used by a downstream operation, and so on. A commit write can include an indication of data ready, data valid, data complete, etc. Since which of the sides of a branch will be taken is unknown a priori, then writing data prior to the determination of which side of the branch direction is taken could present a race condition, provide invalid data, and the like. The commit write can store data in one or more registers, a register file, a cache, storage, etc. In embodiments, the commit write can include a commit write to data storage. The data storage can be located within the array of elements, coupled to the array, accessible by the array through a network such as a computer network, etc. In embodiments, the data storage resides outside of compute elements associated with the branch. Examples of code blocks that can be coalesced by a compiler are shown. The coalesced blocks can include block 510, block 512, block 514, block 516, block 518, block 520, and so on. A coalesced control block can include one or more operations. In embodiments, the control word that was coalesced can be a single control word. The operations within a control block can be executed sequentially. In further embodiments, operations associated with the at least two possible branch paths can be performed in parallel by the 2D array of compute elements.

Furthermore, the coalescing can include multiple control words that include one or more branch decisions as well as subsequent control words that control subsequent operations that may or may not be executed (or have their results ignored), depending on which branch path is chosen. For example, block 516 can include control word 8, which includes branch decision paths D, E, F, and G, and also control word 9, which includes subsequent operations for each of the possible branch decision paths, which operations can be called the branch shadow. Thus the coalescing can comprise speculative encoding of the control word that includes a branch decision and one or more additional control words. And the one or more additional control words can control operations subsequent to the control word that includes a branch decision.

FIG. 5B shows a programming loop coalesced by a compiler. Branch decisions that can be made as part of program execution can support a programming loop 562. The programming loop 562 can be controlled by a branch such as a conditional branch, execution of a subroutine or procedure, and so on. In order to support a programming loop, operations from both the end of the loop and from the beginning of the loop can be coalesced into a control word. A control word, including operations from both the end of the loop and the beginning of the loop, is enabled by a parallel processing architecture using speculative encoding. A compiler is used to coalesce code words represented by the tree 502. The tree comprises seven segments, segment A, segment B, segment C, segment D, segment E, segment F, and segment G. The coalesced control word 550 includes operations associated with the beginning of the loop and the end of the loop. While the beginning of the loop is known a priori to include operations from segment A, which other operations will be executed is not known until branch decisions are made. Thus, the coalesced control word 556 includes operations from segments D, E, F, and G. Other operations from the seven segments that can be coalesced into control words can include control words 552, 554, 556, 558, and 560.

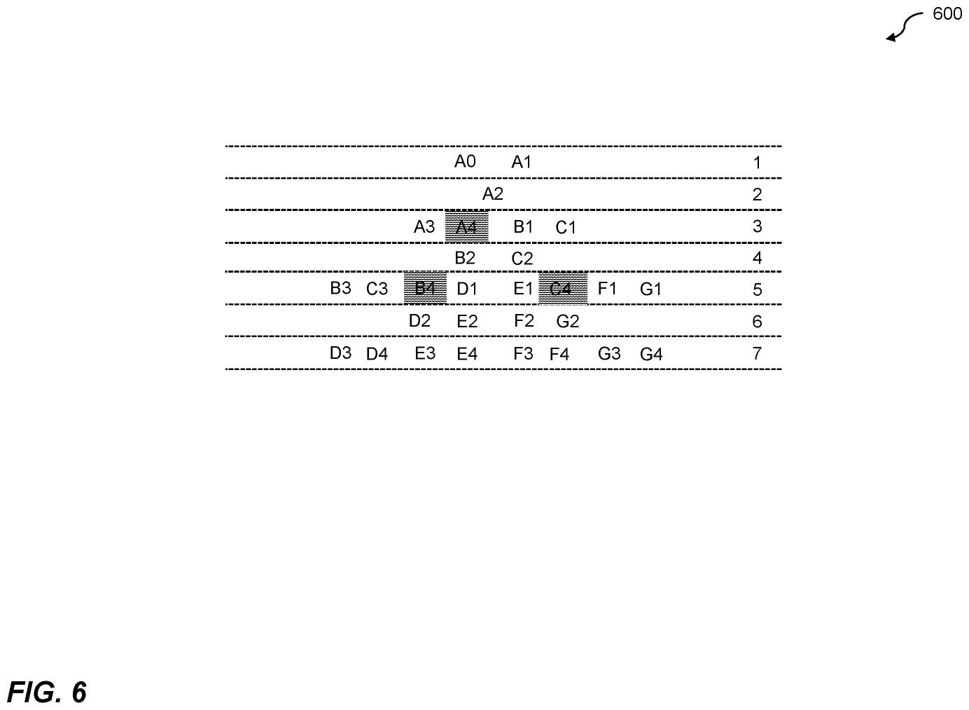

FIG. 6 illustrates a compiler view of a code image. Discussed previously, multiple operations can be coalesced into a control word. The coalescing can include speculatively encoded operations for at least two possible branch paths. Since the coalescing can support parallel execution of set of operations, the number of cycles that are required to execute the operations associated with a path through branches of a program tree can be reduced. In the example 600, the number of cycles to progress along a path through the tree can be reduced to seven cycles. The compiler view of a code image can be enabled by a parallel processing architecture using speculative encoding. A two-dimensional (2D) array of compute elements is accessed, where each compute element within the array of compute elements is known to a compiler and is coupled to its neighboring compute elements within the array of compute elements. Control is provided for the array of compute elements on a cycle-by-cycle basis, where the control is enabled by a stream of wide, variable length, control words generated by the compiler. Two or more operations are coalesced into a control word, where the control word includes a branch decision and operations associated with the branch decision.

A compiler view of a code image that is based on operations that can be coalesced into control words is shown. The operations within the control words can be executed sequentially or in parallel on a cycle-by-cycle basis. In the example shown, operations AO and A1 can be executed in parallel during a first cycle, operation A2 can be executed during a second cycle, and so on. Recall that a coalesced control word can include a branch decision (e.g., which side of a branch is taken) and operations associated with the branch decision. In the figure, there are three branch decisions denoted by operations A4, B4, and C4. The three branch decisions can include conditional branches. An upstream branch decision which can be determined in a previous cycle can determine which branch decision can be selected in a subsequent cycle. In a usage example, a branch decision at A4 that selects branch B, precludes the need to determine a branch decision at C4, since branch C has been eliminated by the branch decision at A4.

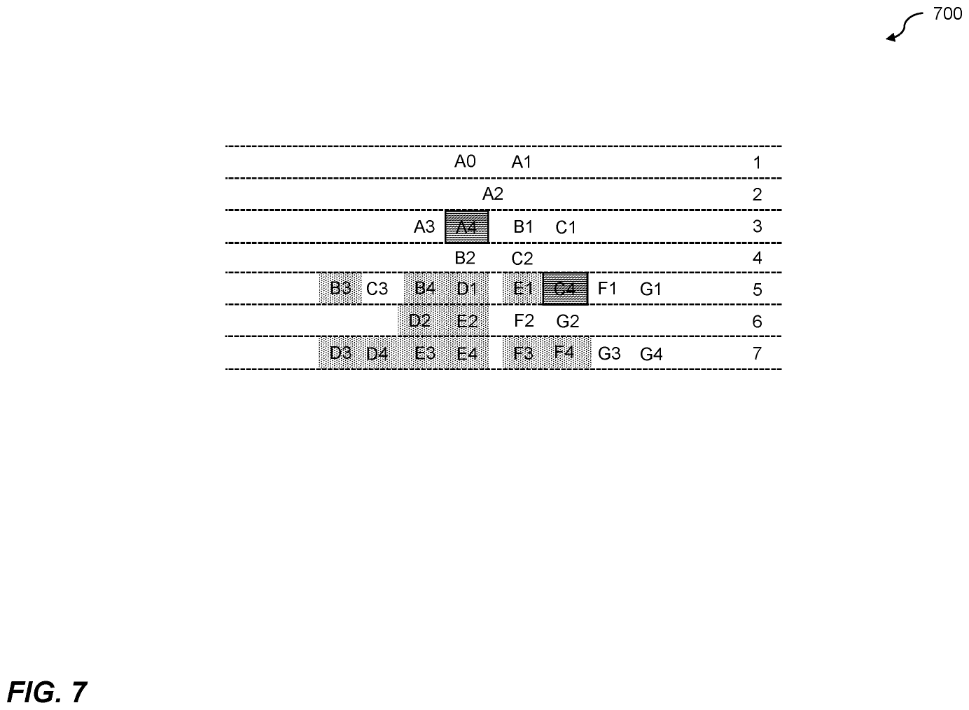

FIG. 7 shows suppressed operations for an expected branch path 700. Branch decisions and coalescing of operations with the branch decisions are described throughout. Further, a branch outcome (e.g., which side of a branch is taken) that is determined in a previous cycle can determine which branch decision to select in a subsequent cycle. In part, this “determinism” can be due to a one cycle latency of branch decision information leaving the array of compute elements. Operations for an expected branch path are enabled by a parallel processing architecture using speculative encoding. Recall that a branch decision, which is used to determine which set of operations to perform and which dataset the operations will act upon, can be implanted using a multiplexer (MUX). As a result, a compressed control word (CCW) can include one or more bits or fields which can be used as input selection lines to the MUX. The input selection lines can select which compute element will receive a potential branch decision signal. In embodiments, two or more potential branches can be supported per cycle. Based on the branch decision, one or more MUX input selection lines, etc., operations associated with the taken side of the branch are processed or executed, while operations associated with one or more untaken sides of the branch are not. The operations associated with the one or more untaken sides of the branch can be ignored, deleted, flushed, and so on.

Further embodiments include suppressing one or more operations associated with the branch decision that are not indicated by the branch decision. The suppressing can include halting execution of the operations, suspending the operations, and so on. In embodiments, the suppressing is accomplished dynamically. The dynamic suppression can be based on a current branch decision, on a previous branch decision, etc. In embodiments, the suppressing can prevent speculative branch execution delay. The delay can include waiting to complete fetches of compressed control words, fetches of data, etc. The suppression of the operations associated with one or more branch decisions that are not indicated can enable reduced numbers of operations that are performed during a given cycle, reduced requests for data, and the like. In embodiments, the suppressing can enable power reduction in the 2D array of compute elements. The power reduction can be accomplished by using techniques such as idling one or more processing elements that are not needed for processing operations during a given cycle. In other embodiments, the suppressing can prevent data from being committed. Committing data can include writing data from the 2D array of compute elements to storage such as external storage.

In a usage example, possible branch decisions A4 and B4 or C4 can be made while performing operations associated with the compiler view of the code image. Branch or path C can be the predicted branch or path. The branch decision at A4 can be to proceed along the C branch, so the operations associated with branches B, D, and E can be suppressed. That is, operations B3, B4, C1, D1, D2, E2, D3, D4, E3, E4, F3, and F4 can be suppressed. Other operations associated with branches D, C, and E can be performed as part of the speculative encoding. Further, no branch decision will be required at B4. The suppressing of the operations associated with B, D, and E can be accomplished by idling compute elements that would have been allocated to perform the operations associated with B, D, and E. The idling of the compute elements can enable power reduction in the 2D array

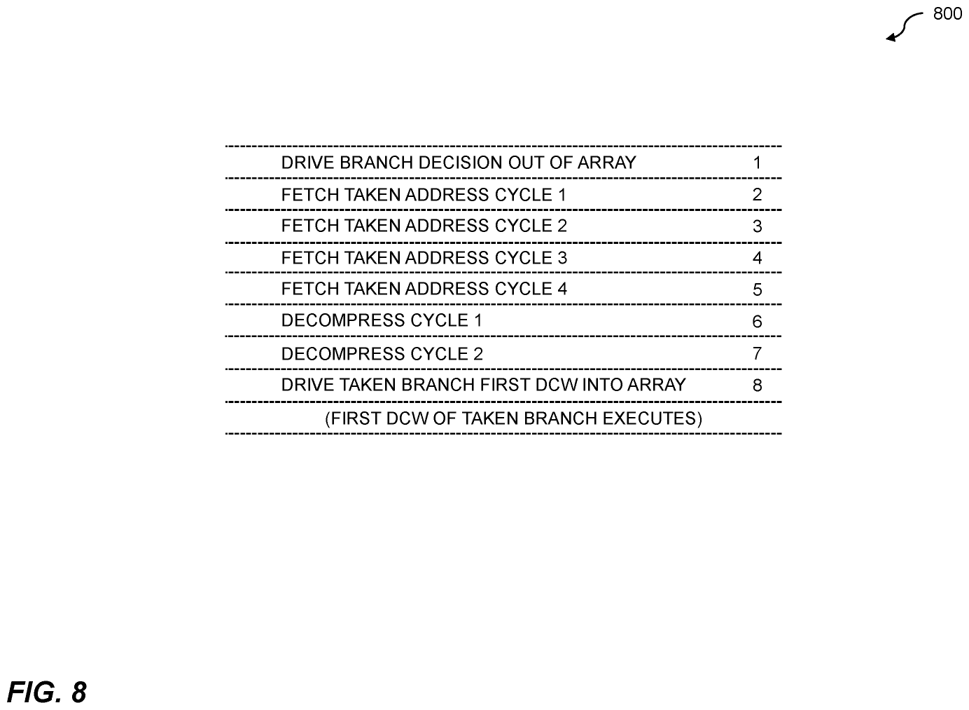

FIG. 8 illustrates a compressed code word fetch and decompress pipeline. Program execution can be based on control words such as compressed control words. The compressed control words can be based on coalesced operations, and can include a branch decision and one or more operations that can be associated with the branch decision. The compressed control words can be fetched from storage and decompressed prior to providing the decompressed control word or words to a 2D array of compute elements. The fetching and decompressing compressed control words enables a parallel processing architecture using speculative encoding. A two-dimensional (2D) array of compute elements is accessed. Control for the array of compute elements is provided on a cycle-by-cycle basis, where the control is enabled by a stream of wide, variable length, control words generated by a compiler. Two or more operations are coalesced into a control word, where the control word includes a branch decision and operations associated with the branch decision.

A compressed code word fetch and decompress pipeline is shown 800. The operations performed within the pipeline are shown, along with associated cycles during which the various operations can be performed. The operations of the pipeline can begin by driving a branch decision out of the array. Referring to the examples discussed previously, the branch decision can include choosing the B branch and the D or E branch, the C branch and the F or G branch, and so on. Based on the branch decision, one or more fetch cycles can be executed. In the example shown, four fetch cycles can be performed. The one or more fetch cycles can be used to fetch one or more compressed control words associated with the branch decision. The one or more compressed control words can be decompressed. One or more decompress cycles can be performed to decompress the one or more compressed control words associated with the taken branch. The decompressed control word is provided or driven into the array of compute elements. The decompressed control word can be executed by the 2D array of compute elements.

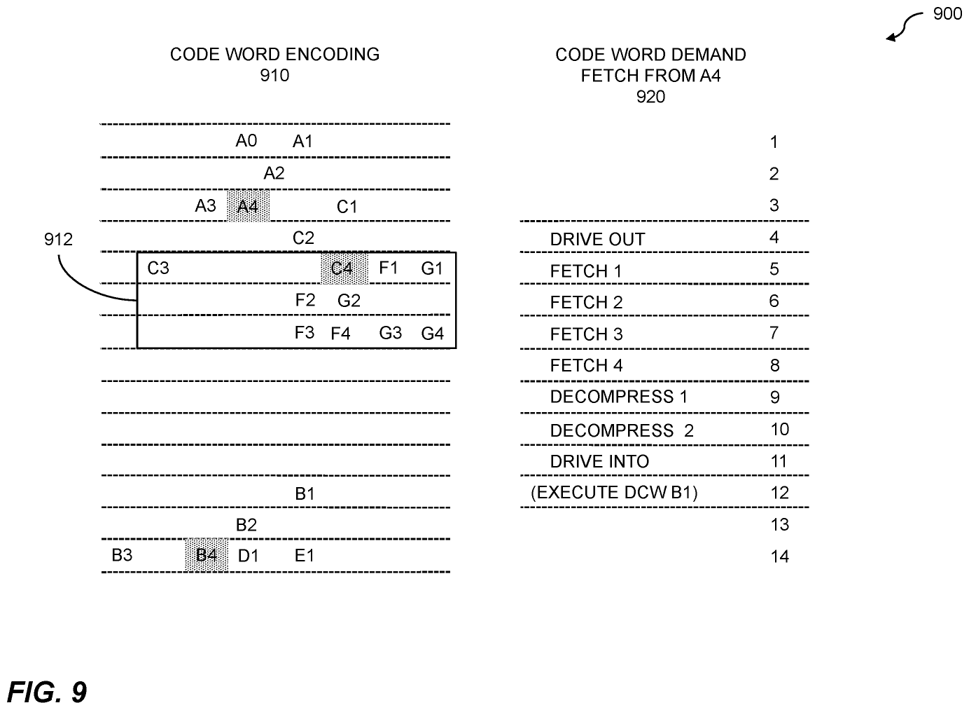

FIG. 9 shows code word encoding and a naive demand-driven fetch pipeline overlay. In the absence of speculative encoding in the encoded control word stream, a fetch to a non-predicted branch can incur significant delay in program execution. An example of naive demand-driven fetch is shown 900, such as a fetch for a non-predicted branch. Code word encodings 910 are shown along with cycles associated with a code word demand fetch 920. The code word demand fetch can be based on a branch decision at A4. In a usage example based on the code trees and fetch and decode pipeline described previously, the branch decision at A4 can occur during cycle 3. The control words associated with the predicted or typical branch decision, that of proceeding along branch C, are shown 912. However, if the branch decision at A4 is to proceed along branch B, then a fetch cycle can be initiated for the non-predicted branch. The control words shown in 912 can be suppressed, where the suppression can include idling compute elements to reduce power consumption by the array. The fetch initiated for the branch B would include driving the branch decision out of the array, four fetch cycles, two decode cycles, and driving the decompressed control word for the taken branch into the array. Execution of the decompressed control word could then begin with B1 (cycle 12). The execution of operation B1 during the twelfth cycle is based on the compressed control word for branch B being available in an L1 cache accessible by the 2D array of compute elements. If the compressed control word is not available in the L1 cache, then further delays can be expected. In embodiments, operations that can be performed can be speculatively encoded into subsequent compressed control words. The operations can be associated with a path taken and a path not taken. The speculative encoding of compressed control words can mitigate generation of side effects such as compute element actions that can require committing. Committing can include writing data to storage outside the 2D array.

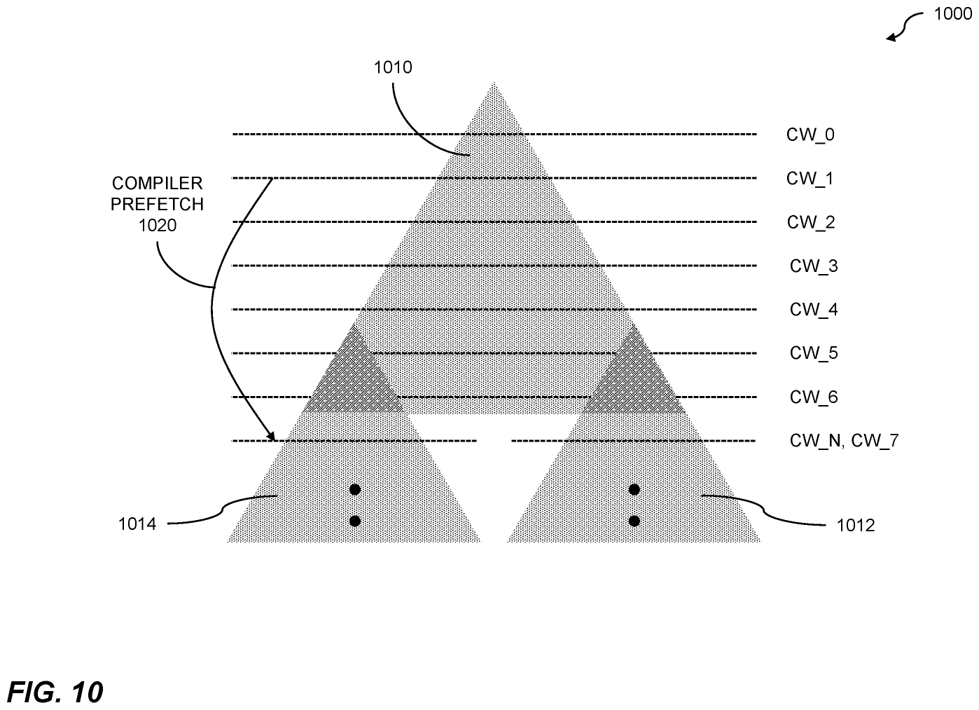

FIG. 10 illustrates a compiler coarse branch prefetch hint. Discussed previously, compiled code can be represented as branches of a tree, where one or more operations can be associated with each branch of the tree. Whether or not the operations of a given branch are executed can be based on a branch decision. The branch decision can be determined based on a value, an expression, and so on. Two or more operations can be coalesced into a control word, where the control word can include a branch decision and operations associated with the branch decision. As the number of branches of the tree increases, the width of the possible cone of execution can also increase. That is, the number of branch decisions and the numbers of operations associated with each of the branch decisions also increase, resulting in larger, single compressed control word sizes. By permitting the stream of compressed control words to diverge into separate streams based on the actual branch decisions made and branches executed, the sizes of the compressed control words can be reduced. However, if the fetching of new compressed control words is not successfully anticipated, then the 2D array of compute elements can stall while the new control word stream is fetched. A compiler-driven prefetch hint within the stream of compressed control words can be used to fetch and decode the start of a likely new decompressed control word stream. The compiler-driven prefetch hint enables a parallel processing architecture using speculative encoding. The fetching and decoding can be accomplished using a two-read one-write (2R1W) level 1 (L1) compressed control word store (e.g., L1 cache) and an additional decompressor.

Example execution cones and a compiler-driven prefetch hint are shown 1000. The execution cone 1010 can include a branch decision. The branch decision can cause execution to process operations based on a first side of a branch 1012 or a second side of the branch 1014. While the execution of the first side of the branch 1012 may be based on the anticipated branch decision, a compiler-driven prefetch hint 1020 can be introduced into the compressed control word stream to prefetch compressed control words associated with the second side of the branch 1014. Thus, when the branch decision in cone 1010 is determined, then execution of decompressed control words with either the first side 1012 or the second side 1014 can be initiated without stalling the 2D array of compute elements.

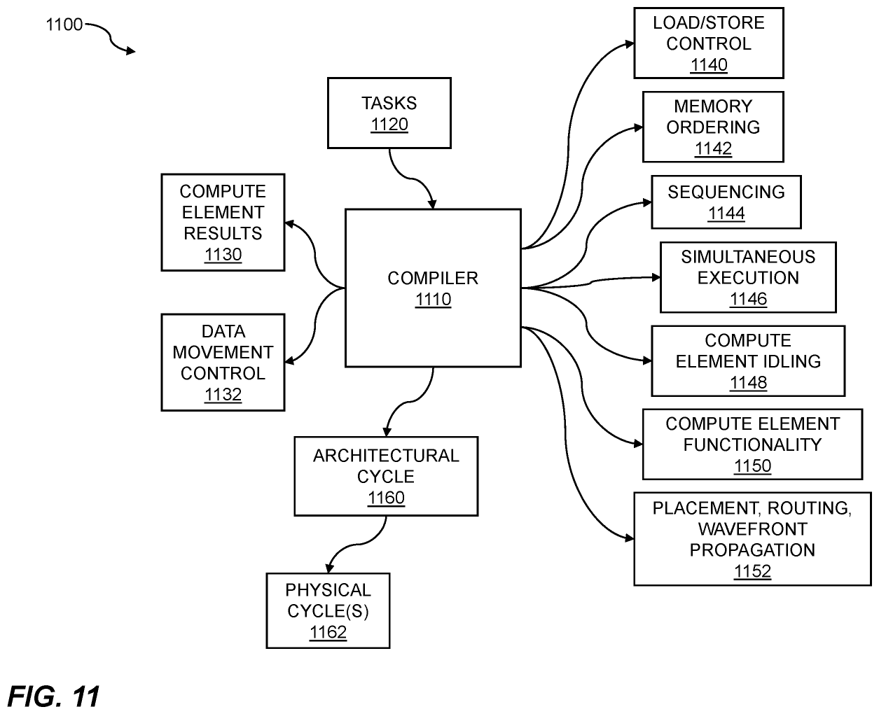

FIG. 11 shows a system block diagram for compiler interactions. Discussed throughout, compute elements within a 2D array are known to a compiler which can compile tasks and subtasks for execution on the array. The compiled tasks and subtasks are executed to accomplish task processing. A variety of interactions, such as placement of tasks, routing of data, and so on, can be associated with the compiler. The compiler interactions enable a parallel processing architecture using speculative encoding. A two-dimensional (2D) array of compute elements is accessed. Each compute element within the array of compute elements is known to a compiler and is coupled to its neighboring compute elements within the array of compute elements. Control for the array of compute elements is provided on a cycle-by-cycle basis. The control is enabled by a stream of wide, variable length, control words generated by the compiler. The control can include a two- or more way branch operation. Two or more operations are coalesced into a control word. The control word includes a branch decision and operations associated with the branch decision.

The system block diagram 1100 includes a compiler 1110. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as low-level virtual machine (LLVM) intermediate representation (IR). The compiler can generate a set of directions that can be provided to the computer elements and other elements within the array. The compiler can be used to compile tasks 1120. The tasks can include a plurality of tasks associated with a processing task. The tasks can further include a plurality of subtasks. The tasks can be based on an application such as a video processing or audio processing application. In embodiments, the tasks can be associated with machine learning functionality. The compiler can generate directions for handling compute element results 1130. The compute element results can include results derived from arithmetic, vector, array, and matrix operations; Boolean operations; and so on. In embodiments, the compute element results are generated in parallel in the array of compute elements. Parallel results can be generated by compute elements when the compute elements can share input data, use independent data, and the like. The compiler can generate a set of directions that controls data movement 1132 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement.

As with a general-purpose compiler used for generating tasks and subtasks for execution on one or more processors, the compiler can provide directions for task and subtasks handling, input data handling, intermediate and result data handling, and so on. The compiler can further generate directions for configuring the compute elements, storage elements, control units, ALUs, and so on, associated with the array. As previously discussed, the compiler generates directions for data handling to support the task handling. In the system block diagram, the data movement can include loads and stores 1140 with a memory array. The loads and stores can include handling various data types such as integer, real or float, double-precision, character, and other data types. The loads and stores can load and store data into local storage such as registers, register files, caches, and the like. The caches can include one or more levels of cache such as a level 1 (L1) cache, level 2 (L2) cache, level 3 (L3) cache, and so on. The loads and stores can also be associated with storage such as shared memory, distributed memory, etc. In addition to the loads and stores, the compiler can handle other memory and storage management operations including memory precedence. In the system block diagram, the memory access precedence can enable ordering of memory data 1142. Memory data can be ordered based on task data requirements, subtask data requirements, and so on. The memory data ordering can enable parallel execution of tasks and subtasks.

In the system block diagram 1100, the ordering of memory data can enable compute element result sequencing 1144. In order for task processing to be accomplished successfully, tasks and subtasks must be executed in an order that can accommodate task priority, task precedence, a schedule of operations, and so on. The memory data can be ordered such that the data required by the tasks and subtasks can be available for processing when the tasks and subtasks are scheduled to be executed. The results of the processing of the data by the tasks and subtasks can therefore be ordered to optimize task execution, to reduce or eliminate memory contention conflicts, etc. The system block diagram includes enabling simultaneous execution 1146 of two or more potential compiled task outcomes based on the set of directions. The code that is compiled by the compiler can include branch points, where the branch points can include computations or flow control. Flow control transfers instruction execution to a different sequence of instructions. Since the result of a branch decision, for example, is not known a priori, then the sequences of instructions associated with the two or more potential task outcomes can be fetched, and each sequence of instructions can begin execution. When the correct result of the branch is determined, then the sequence of instructions associated with the correct branch result continues execution, while the branches not taken are halted and the associated instructions flushed. In embodiments, the two or more potential compiled outcomes can be executed on spatially separate compute elements within the array of compute elements.

The system block diagram includes compute element idling 1148. In embodiments, the set of directions from the compiler can idle an unneeded compute element within a row of compute elements located in the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 1150. The compute element functionality can enable various types of compute architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wave-front propagation 1152 within the array of compute elements. The compiler can generate directions or instructions that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wave-front propagation. The compiler can direct 2D wave-front execution flow in the array to foster computation wave-front propagation in the array to support multiple threads of execution to exchange results or operands by intersecting in both 2D space and in time.

In the system block diagram, the compiler can control architectural cycles 1160. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture rather than to low level operations. One or more architectural cycles are controlled by the compiler. An architectural cycle is that cycle controlled by a single control word. When the array is paused, the memory system continues to run on “wall clock” time (or “wall clock” cycles). Hence architectural cycles do not equal wall clock cycles. The closer the number of architectural cycles is to wall clock cycles, the better the architectural efficiency of the system, which includes both compiler and hardware efficiency. Execution of an architectural cycle can be dependent on two or more conditions. In embodiments, an architectural cycle can occur when a control word is available to be pipelined into the array of compute elements and when all data dependencies are met. That is, the array of compute elements does not have to wait for either dependent data to load or for a full memory queue to clear, In the system block diagram, the architectural cycle can include one or more physical cycles 1162. A physical cycle can refer to one or more cycles at the element level required to implement a load, an execute, a write, and so on. In embodiments, the set of directions can control the array of compute elements on a physical cycle-by-cycle basis. The physical cycles can be based on a clock such as a local, module, or system clock, or some other timing or synchronizing technique. In embodiments, the physical cycle-by-cycle basis can include an architectural cycle. The physical cycles can be based on an enable signal for each element of the array of elements, while the architectural cycle can be based on a global, architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. In other embodiments, the compiler can provide, via the control word, operand size information for each column of the array of compute elements. The operand size is used to determine how many load operations may be required to obtain data, because an operand may straddle multiple data banks or multiple cache lines, which may require multiple accesses. Various operand sizes can be used. In embodiments, the operand size can include bytes, half-words, words, and double-words.

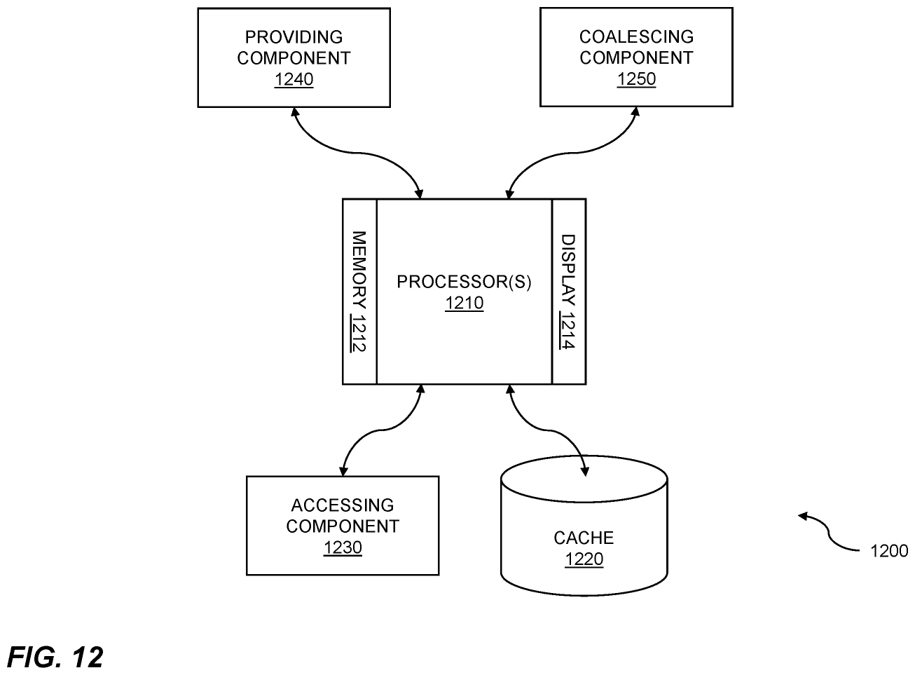

FIG. 12 is a system diagram for parallel processing. The parallel processing is performed in a parallel processing architecture, where the parallel processing architecture uses speculative encoding. The system 1200 can include one or more processors 1210, which are attached to a memory 1212 which stores instructions. The system 1200 can further include a display 1214 coupled to the one or more processors 1210 for displaying data; intermediate steps; directions; control words; compressed control words; control words implementing Very Long Instruction Word (VLIW) functionality; topologies including systolic, vector, cyclic, spatial, streaming, or VLIW topologies; and so on. In embodiments, one or more processors 1210 are coupled to the memory 1212, wherein the one or more processors, when executing the instructions which are stored, are configured to: access a two-dimensional (2D) array of compute elements, wherein each compute element within the array of compute elements is known to a compiler and is coupled to its neighboring compute elements within the array of compute elements; provide control for the array of compute elements on a cycle-by-cycle basis, wherein the control is enabled by a stream of wide, variable length, control words generated by the compiler; and coalesce two or more operations into a control word, wherein the control word includes a branch decision and operations associated with the branch decision. In embodiments, the control word that was coalesced includes speculatively encoded operations for at least two possible branch paths. The at least two possible branch paths can generate independent side effects. In other embodiments, the at least two possible branch paths can generate compute element actions where the compute element actions must be committed. Committing a compute element action can include storing compute element action results in storage. The operations can be performed on data that can be promoted, where the promoted data can be used for a downstream operation. The downstream operation can include an arithmetic or Boolean operation, a matrix operation, and so on. The two or more possible branch paths can include an indicated branch decision and one or more branch decisions that are not indicated. One or more one or more operations associated with a branch decision that is not indicated by the branch decision can be suppressed. The suppressing operations can enable power reduction in the 2D array of compute elements. The compute elements can include compute elements within one or more integrated circuits or chips; compute elements or cores configured within one or more programmable chips such as application specific integrated circuits (ASICs); field programmable gate arrays (FPGAs); heterogeneous processors configured as a mesh; standalone processors; etc.

The system 1200 can include a cache 1220. The cache 1220 can be used to store data such as data associated with the branch decisions, directions to compute elements, control words, intermediate results, microcode, and so on. The cache can comprise a small, local, easily accessible memory available to one or more compute elements. In embodiments, the data that is stored can include data associated with the two or more branch decisions. Data associated with an indicated branch decision can be promoted for a downstream operation, while data associated with branch decision not indicated can be ignored. Embodiments include storing relevant portions of a direction or a control word within the cache associated with the array of compute elements. The cache can be accessible to one or more compute elements. The cache, if present, can include a dual read, single write (2R1W) cache. That is, the 2R1W cache can enable two read operations and one write operation contemporaneously without the read and write operations interfering with one another. The system 1200 can include an accessing component 1230. The accessing component 1230 can include control logic and functions for accessing a two-dimensional (2D) array of compute elements, wherein each compute element within the array of compute elements is known to a compiler and is coupled to its neighboring compute elements within the array of compute elements. A compute element can include one or more processors, processor cores, processor macros, and so on. Each compute element can include an amount of local storage. The local storage may be accessible to one or more compute elements. Each compute element can communicate with neighbors, where the neighbors can include nearest neighbors or more remote “neighbors”. Communication between and among compute elements can be accomplished using a bus such as an industry standard bus, a ring bus, a network such as a wired or wireless computer network, etc. In embodiments, the ring bus is implemented as a distributed multiplexor (MUX). Discussed below, operations associated with an indicated branch decision can be executed, while operations associated with a branch decision that is not indicated can be suppressed.

The indicated branch decision can be based by code conditionality, where the conditionality can be established by the compiler via the control word(s). The decision reached in a compute element is then selected to be examined by the control unit. Code conditionality can include a branch point, a decision point, a condition, and so on. In embodiments, the conditionality can determine code jumps. A code jump can change code execution from a sequential execution of instructions to execution of a different set of instructions. In a usage example, a 2R1W cache can support simultaneous fetch of operations associated with coalesced code words. Since the branch decision indicated by a direction or control word containing a branch can be data dependent and is therefore not known a priori, then control words associated with more than one branch decisions can be fetched prior to execution (prefetch) of the branch control word. As discussed elsewhere, an initial part of the two or more branch paths based on branch decisions can be instantiated in a succession of coalesced control words. When the correct branch decision is determined, the computations associated with the branch decision not indicated can be suppressed.

The system 1200 can include a providing component 1240. The providing component 1240 can include control and functions for providing control for the array of compute elements on a cycle-by-cycle basis, wherein the control is enabled by a stream of wide, variable length, control words generated by the compiler. The control words can be based on low-level control words such as assembly language words, microcode words, and so on. The control of the array of compute elements on a cycle-by-cycle basis can include configuring the array to perform various compute operations. In embodiments, the stream of wide, variable length, control words generated by the compiler provide direct, fine-grained control of the 2D array of compute elements. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control can enable machine learning functionality for the neural network topology.

A branch decision can be part of a compiled task, which can be one of many tasks associated with a processing job. The compiled task can be executed on one or more compute elements within the array of compute elements. In embodiments, the executing of the compiled task can be distributed across compute elements in order to parallelize the execution. The executing the compiled task can include executing the tasks for processing multiple datasets (e.g., single instruction multiple data or SIMD execution). Embodiments can include providing simultaneous execution of two or more potential compiled task outcomes. Recall that the provided control word or words can control code conditionality for the array of compute elements. In embodiments, the two or more potential compiled task outcomes comprise a computation result or a flow control. The code conditionality, which can be based on computing a condition such as a value, a Boolean equation, and so on, can cause execution of one of two or more sequences of instructions, based on the condition. In embodiments, the two or more potential compiled outcomes can be controlled by a same control word. In other embodiments, the conditionality can determine code jumps. The two or more potential compiled task outcomes can be based on one or more branch paths, data, etc. The executing can be based on one or more directions or control words. Since the potential compiled task outcomes are not known a priori to the evaluation of the condition, the set of directions can enable simultaneous execution of two or more potential compiled task outcomes. When the condition is evaluated, then execution of the set of directions that is associated with the condition can continue, while the set of directions not associated with the condition (e.g., the path not taken) can be halted, flushed, and so on. In embodiments, the same direction or control word can be executed on a given cycle across the array of compute elements. The executing tasks can be performed by compute elements located throughout the array of compute elements. In embodiments, the two or more potential compiled outcomes can be executed on spatially separate compute elements within the array of compute elements. Using spatially separate compute elements can enable reduced storage, bus, and network contention; reduced power dissipation by the compute elements; etc.

The system 1200 can include a coalescing component 1250. The coalescing component 1250 can include control logic and functions for coalescing two or more operations into a control word, wherein the control word includes a branch decision and operations associated with the branch decision. In embodiments, the control word that was coalesced is a single control word. Recall that code, a program, an application, an app, and so on is executed on the array of compute elements. The execution of the code, program, etc., can be thought of as a tree, where each branch of the tree can be associated with a branch decision. The exact path through the tree associated with the execution is not known a priori. In embodiments, the control word that was coalesced can include speculatively encoded operations for at least two possible branch paths. The branch can include other numbers of possible branch paths. The coalescing of encoding operations can be based on one or more conditions. In embodiments, the at least two possible branch paths can generate independent side effects. Side effects can include program execution stalls, increases in apparent functional density of compressed control words, and so on. In other embodiments, the at least two possible branch paths can generate compute element actions that must be committed. Actions that must be committed can include accesses such as writes to storage, where storage can be beyond the array of compute elements. In further embodiments, the operations for at least two possible branch paths can be performed in parallel by the 2D array of compute elements. Parallel execution can be performed when the at least two possible branch paths operate on the same data, operate on independent data (e.g., single instruction multiple data (SIMD) execution), etc. In some codes, programs, etc., a branch decision can support a program loop. The program loop can include a conditional loop or an unconditional loop. In embodiments, the coalescing can include operations from both the end of the loop and the beginning of the loop. Discussed throughout, the execution of a code, program, etc., can be associated with operational cycles of the 2D array of compute elements. In embodiments, the coalescing can include two or more operational cycles of the cycle-by-cycle basis. The coalescing can be used to control a number of operational cycles. In embodiments, the coalescing can enable a reduction of operational cycles of the cycle-by-cycle basis. The reduction of operational cycles can be accomplished by performing two or more operations in a given cycle, combining read or write operations within a cycle, etc.

The system 1200 can include a computer program product embodied in a non-transitory computer readable medium for task processing, the computer program product comprising code which causes one or more processors to perform operations of: accessing a two-dimensional (2D) array of compute elements, wherein each compute element within the array of compute elements is known to a compiler and is coupled to its neighboring compute elements within the array of compute elements; providing control for the array of compute elements on a cycle-by-cycle basis, wherein the control is enabled by a stream of wide, variable length, control words generated by the compiler; and coalescing two or more operations into a control word, wherein the control word includes a branch decision and operations associated with the branch decision.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for program execution comprising:
accessing a two-dimensional (2D) array of compute elements, wherein each compute element within the array of compute elements is known to a compiler and is coupled to its neighboring compute elements within the array of compute elements;
providing control for the array of compute elements on a cycle-by-cycle basis, wherein the control is enabled by a stream of wide, variable length, control words generated by the compiler; and
coalescing two or more operations into a control word, wherein the control word includes a branch decision and operations associated with the branch decision.

2. The method of claim 1 wherein the control word that was coalesced includes speculatively encoded operations for at least two possible branch paths.

3. The method of claim 2 wherein the at least two possible branch paths generate independent side effects.

4. The method of claim 2 wherein the at least two possible branch paths generate compute element actions that must be committed.

5. The method of claim 2 wherein the operations for at least two possible branch paths can be performed in parallel by the 2D array of compute elements.

6. The method of claim 1 wherein the branch decision supports subroutine execution. The method of claim 1 wherein the branch decision supports a programming loop.

8. The method of claim 7 wherein the coalescing includes operations from both the end of the loop and the beginning of the loop.

9. The method of claim 1 wherein the two or more operations control data flow within the 2D array of compute elements.

10. The method of claim 1 wherein the control word that was coalesced is a single control word.

11. The method of claim 1 further comprising suppressing one or more operations associated with the branch decision that are not indicated by the branch decision.

12. The method of claim 11 wherein the suppressing is accomplished dynamically.

13. The method of claim 11 wherein the suppressing enables power reduction in the 2D array of compute elements.

14. The method of claim 11 wherein the suppressing prevents data from being committed.

15. The method of claim 1 wherein the coalescing comprises speculative encoding of the control word that includes a branch decision and one or more additional control words.

16. The method of claim 15 wherein the one or more additional control words control operations subsequent to the control word that includes a branch decision.

17. The method of claim 1 further comprising ignoring one or more operations associated with the branch decision that are not indicated by the branch decision.

18. The method of claim 17 wherein the ignoring is accomplished by setting an idle bit in the control word.

19. The method of claim 1 wherein the coalescing includes two or more operational cycles of the cycle-by-cycle basis.

20. The method of claim 19 wherein the coalescing enables a reduction of operational cycles of the cycle-by-cycle basis.

21. The method of claim 1 wherein each operation from the operations represents an instruction equivalent.

22. The method of claim 21 wherein the instruction equivalent comprises a building block for a high-level language.

23. The method of claim 1 wherein the stream of wide, variable length, control words generated by the compiler provide direct, fine-grained control of the 2D array of compute elements.

24. A computer program product embodied in a non-transitory computer readable medium for program execution, the computer program product comprising code which causes one or more processors to perform operations of:
accessing a two-dimensional (2D) array of compute elements, wherein each compute element within the array of compute elements is known to a compiler and is coupled to its neighboring compute elements within the array of compute elements;
providing control for the array of compute elements on a cycle-by-cycle basis, wherein the control is enabled by a stream of wide, variable length, control words generated by the compiler; and
coalescing two or more operations into a control word, wherein the control word includes a branch decision and operations associated with the branch decision.

25. A computer system for program execution comprising:
a memory which stores instructions;
one or more processors coupled to the memory, wherein the one or more processors, when executing the instructions which are stored, are configured to:
access a two-dimensional (2D) array of compute elements, wherein each compute element within the array of compute elements is known to a compiler and is coupled to its neighboring compute elements within the array of compute elements;
provide control for the array of compute elements on a cycle-by-cycle basis, wherein the control is enabled by a stream of wide, variable length, control words generated by the compiler; and
coalesce two or more operations into a control word, wherein the control word includes a branch decision and operations associated with the branch decision.
